(19) United States
(12) Patent Application Publication
(10) Pub. No.: US 2015/0288007 A1
(43) Pub. Date: Oct. 8, 2015

(54) FUEL CELL SYSTEM CONTROL USING AN INFERRED MASS AIR FLOW

(71) Applicant: Ford Global Technologies, LLC, Dearborn, MI (US)

(72) Inventors: Hans Gangwar, Livonia, MI (US); Milos Milacic, New Boston, MI (US)

(73) Assignee: Ford Global Technologies, LLC, Dearborn, MI (US)

(21) Appl. No.: 14/244,021

(22) Filed: Apr. 3, 2014

(51) Int. Cl. H01M 8/04

(52) U.S. Cl. CPC H01M 8/04104

(57) ABSTRACT

A fuel cell system includes a fuel cell stack for generating power, a compressor providing an air stream to the stack, and a controller. The controller is configured to, in response to determining a mass air flow through the compressor from a lookup table using a speed of the compressor and a pressure ratio across the compressor, operate the fuel cell system based on the mass air flow. A method for controlling a fuel cell system includes receiving first and second signals at a controller indicative of air pressure upstream and downstream of a compressor respectively, and receiving a third signal at the controller indicative of a speed of the compressor. The fuel cell system is operated at a desired mass air flow based on an inferred mass air flow determined using the first, second, and third signals.

### TECHNICAL FIELD

Various embodiments relate to a system and a method for controlling an air stream in a fuel cell system.

### BACKGROUND

It is known that a number of fuel cells are joined together to form a fuel cell stack. Such a stack generally provides electrical current in response to electrochemically converting hydrogen and oxygen into water. The electrical current generated in such a process is used to drive various devices in a vehicle or other such apparatus. A supply generally provides hydrogen to the fuel cell stack. The fuel cell stack also receives an oxygen supply, which may be in the form of an air stream. The supply of hydrogen and oxygen, including mass flow rates and pressures may be controlled during fuel cell operation.

### SUMMARY

According to an embodiment, a fuel cell system is provided with a fuel cell stack and a compressor providing an air stream to the fuel cell stack. A first pressure sensor is adapted to measure a first air pressure at a first location in the system. A second pressure sensor is adapted to measure a second air pressure of the air stream at a second location in the system. A controller is configured to (i) infer a mass air flow of the air stream using a speed of the compressor and a pressure ratio across the compressor, the pressure ratio being determined from the first air pressure and the second air pressure, and (ii) control an operation of the fuel cell stack using the mass air flow through the compressor.

According to another embodiment, a fuel cell system is provided with a fuel cell stack for generating power, a compressor providing an air stream to the stack, and a controller. The controller is configured to, in response to determining a mass air flow through the compressor from a lookup table using a speed of the compressor and a pressure ratio across the compressor, operate the fuel cell system based on the mass air flow.

According to yet another embodiment, a method for controlling a fuel cell system is provided. The method includes receiving first and second signals at a controller indicative of air pressure upstream and downstream of a compressor respectively, and receiving a third signal at the controller indicative of a speed of the compressor. The fuel cell system is operated at a desired mass air flow based on an inferred mass air flow determined using the first, second, and third signals.

Various embodiments of the present disclosure have associated, non-limiting advantages. For example, operation of a fuel cell system uses a control algorithm. The control method may use feedback sensors. The fuel cell stack uses air and hydrogen at a desired pressure, flow, and humidity to produce electrical current. The control method and controller controls a compressor, such as an electronic supercharger, to deliver the desired air pressure and flow. A conventional system uses a mass air flow sensor and one or more air pressure sensors. Each sensor used in the fuel cell system increases the cost and complexity of the fuel cell system. The present disclosure provides for a fuel cell system without a mass air flow sensor where the controller infers the mass air flow based on the speed of the compressor and the pressure drop across the compressor. The controller may also use a control valve position, where the valve position sets a back pressure in the system, in inferring the mass air flow. Other pressure drops in the system may be considered by the controller including the air inlet or induction system, the air humidification system, etc. The controller uses a method that controls the operation of the fuel cell system to a desired mass air flow and air pressure based on the inferred mass air flow, which is a function of pressure ratio across the compressor, the compressor speed, and/or the valve position. The controller may use a feedback loop or a lookup table to determine the inferred mass air flow.

### BRIEF DESCRIPTION OF THE DRAWINGS

FIG. 1 is a schematic of an embodiment of a fuel cell system according to an embodiment;

FIG. 2 is a flow chart illustrating a method of determining mass air flow for a fuel cell system according to an embodiment;

FIG. 3 is a schematic illustrating a lookup table for determining mass air flow according to an embodiment; and

FIG. 4 is a graph illustrating measured and inferred mass air flow for a fuel cell system according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. Description of constituents in chemical terms refers to the constituents at the time of addition to any combination specified in the description, and does not necessarily preclude chemical interactions among constituents of the mixture once mixed.

It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

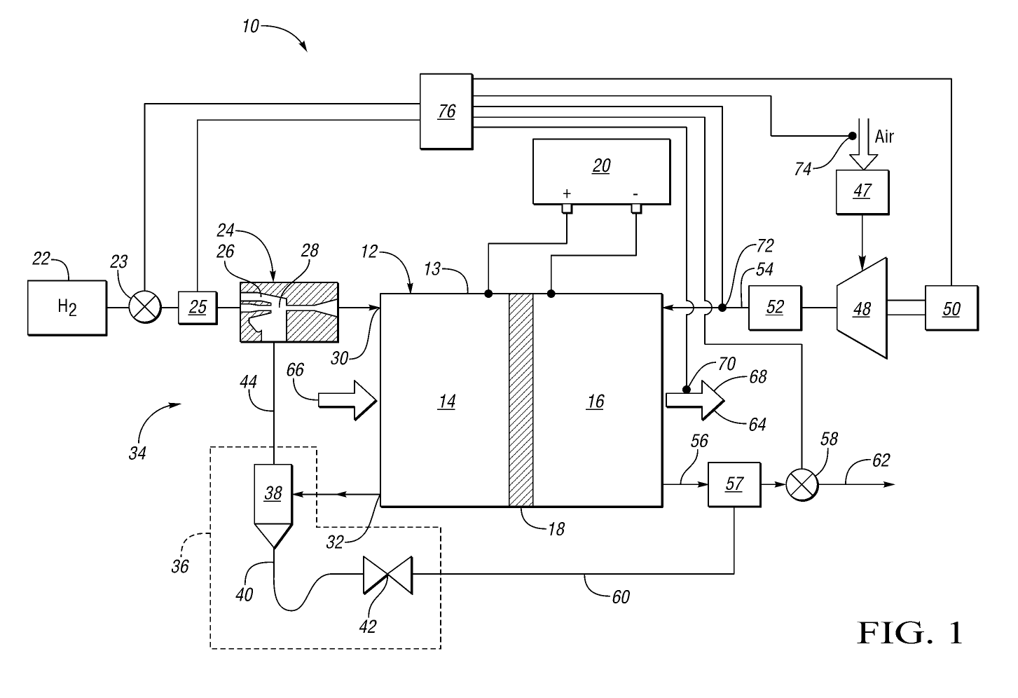

FIG. 1 schematically illustrates a fuel cell system (“the system”) 10 as a process flow diagram according to at least one embodiment. For example, system 10 may be used in a vehicle to provide electrical power to operate an electric motor to propel the vehicle or perform other vehicle functions. The system 10 may be implemented in a fuel cell based electric vehicle or a fuel cell based hybrid vehicle or any other such apparatus that uses electrical current to drive various devices.

The system 10 has a fuel cell stack (“the stack”) 12. The stack 12 includes multiple cells, with each cell 13 having an anode side 14, a cathode side 16, and a membrane 18 therebetween. Only one fuel cell 13 of the fuel cell stack 12 is illustrated in FIG. 1, although the stack 12 contains any number of cells. The stack 12 electrically communicates with and provides energy, for example, to a high voltage bus 20 or a traction battery. The stack 12 generates stack current in response to electrochemically converting hydrogen and oxygen. The stack 12 may also have a cooling loop (not shown).

Various electrical devices may be coupled to the battery 20 to consume such power in order to operate. If the system 10 is used in connection with a vehicle, the devices may include a motor or a plurality of vehicle electrical components that each consume power to function for a particular purpose. For example, such devices may be associated with and not limited to a vehicle powertrain, cabin heating and cooling, interior/exterior lighting, entertainment devices, and power locking windows. The particular types of devices implemented in the vehicle may vary based on vehicle content, the type of motor used, and the particular type of fuel cell stack implemented.

During operation of the system 10, the flow of hydrogen and oxygen is controlled to control the desired chemical reaction between the hydrogen and oxygen and the electrical output of the fuel cell stack 12. The flow of hydrogen and oxygen may be varied depending on the desired electrical output of the stack 12, ambient temperature, altitude, and other factors. The oxygen flow may be provided from the ambient air, which is a mixture that includes primarily oxygen and nitrogen, as well as other gases.

The reaction of the hydrogen and oxygen produces product water, residual fuel such as hydrogen, and byproducts such as nitrogen, that may accumulate at the anode side 14 of the stack 12. These constituents may be collected in a purge assembly 36 downstream of the stack 12, separate at least a portion of the liquid water and/or nitrogen, and return the remaining constituents to the stack 12 via a return passageway in a recirculation loop.

A primary fuel source 22 is connected to the anode side 14 of the stack 12, such as a primary hydrogen source, to provide a supply fuel stream (or an anode stream). Non-limiting examples of the primary hydrogen source 22 are a high-pressure hydrogen storage tank or a hydride storage device. For example, liquid hydrogen, hydrogen stored in various chemicals such as sodium borohydride or alanates, or hydrogen stored in metal hydrides may be used instead of compressed gas. A tank valve 23 controls the flow of the supply hydrogen. A pressure regulator 25 regulates the flow of the supply hydrogen.

The hydrogen source 22 is connected to one or more ejectors 24 or other hydrogen flow control devices. The ejector 24 may be a variable or multistage ejector or other suitable ejector. The ejector 24 is configured to combine the supply hydrogen (e.g., hydrogen received from the source 22) with unused hydrogen (e.g., recirculated from the fuel cell stack 12) to generate an input fuel stream. The ejector 24 controls the flow of the input fuel stream to the stack 12. The ejector 24 has a nozzle 26 supplying hydrogen into the converging section of a converging-diverging nozzle 28. The diverging section of the nozzle 28 is connected to the input 30 of the anode side 14.

The output 32 of the anode side 14 is connected to a recirculation loop 34. The recirculation loop 34 may be a passive recirculation loop, as shown, or may be an active recirculation loop according to another embodiment. Typically, an excess of hydrogen gas is provided to the anode side 14 to ensure that there is sufficient hydrogen available to all of the cells in the stack 12. In other words, under normal operating conditions, hydrogen is provided to the fuel cell stack 12 above a stoichiometric ratio of one, i.e. at a fuel-rich ratio relative to exact electrochemical needs. The unused fuel stream, or recirculated fuel stream, at the anode output 32 may include various impurities such as nitrogen and water both in liquid and vapor form in addition to hydrogen. The recirculation loop 34 is provided such that excess hydrogen unused by the anode side 14 is returned to the input 30 so it may be used and not wasted.

Accumulated liquid and vapor phase water is an output of the anode side 14. The anode side 14 requires humidification for efficient chemical conversion and to extend membrane life. The recirculation loop 34 may be used to provide water to humidify the supply hydrogen gas before the input 30 of the anode side 14. Alternatively, a humidifier may be provided to add water vapor to the input fuel stream.

The recirculation loop 34 may contain a purging assembly 36 to remove impurities or byproducts such as excess nitrogen, liquid water, and/or water vapor from the recirculation stream. According to one example, the purging assembly 36 includes a water separator 38, a drain line 40 and a control valve 42, such as a purge valve. The separator 38 receives a stream or fluid mixture of hydrogen gas, nitrogen gas, and water from the output 32 of the anode side 14. The water may be mixed phase and contain both liquid and vapor phase water. The separator 38 removes at least a portion of the liquid phase water, which exits the separator through drain line 40. At least a portion of the nitrogen gas, hydrogen gas, and vapor phase water may also exit the drain line 40, and pass through a control valve 42, for example, during a purge process of the fuel cell stack 12. The control valve 42 may be a solenoid valve or other suitable valve. The remainder of the fluid in the separator 38 exits through passageway 44 in the recirculation loop 34, which is connected to the ejector 24. The stream in passageway 44 may contain a substantial amount of hydrogen compared to the stream in drain line 40. The fluid in passageway 44 is fed into the converging section of the converging-diverging nozzle 28 where it mixes with incoming hydrogen from the nozzle 26 and hydrogen source 22.

The cathode side 16 of the stack 12 receives oxygen in a cathode stream, for example, as a constituent in an air source 46 such as atmospheric air, or ambient air in the environment surrounding the fuel cell system 10. In one embodiment, air at 46 flows into an air intake system 47 to provide the air stream containing oxygen to the stack 12. The air intake system 47 may include an intake manifold and/or an air filter.

The air stream flows from the intake system 47 to a compressor 48. The compressor 48 is driven by a motor 50 to pressurize the incoming air. The compressor 48 may be a fan, gas compressor, air pump, electric supercharger, or other device suitable for driving an air stream. The compressor 48 may pressurize and/or increase the density of the air stream. The compressor 48 provides a mass air flow (MAF) to the stack 12. The pressurized air, or cathode stream, may be humidified by a humidifier 52 before entering the cathode side 16 at inlet 54. The water added by the humidifier 52 to the cathode stream may be needed to ensure that membranes 18 for each cell 13 remain humidified to provide for optimal operation of the stack 12.

The output 56 of the cathode side 16 is configured to discharge excess air. The output 56 may be connected to a water recovery system 57. The output 56 may also be connected to a valve 58. The valve 58 may be an control valve where flow across the valve is controlled based on a position of the valve, and as the valve closes, the back pressure, or pressure upstream of the valve increases. The valve 58 may be controlled electronically, mechanically, or otherwise as is known in the art. In other examples the valve 58 may be an automatic flow control valve, such as a spring loaded check valve or the like, where a pressure of the cathode stream automatically controls the position of the valve and flow through the valve.

The water recovery system 57 may be upstream (as shown) or downstream of the valve 58. The water recovery system 57 may be a fitting having a drain line 60 connected to the purging assembly 36. In other examples, the water recovery system 57 may be a stand-alone system similar to the purging assembly 36. In other embodiments, the drain lines may be plumbed to other locations in the system 10. The air stream from the stack may be connected to an outlet 62 downstream of the valve 58.

The stack 12 may be cooled using a coolant loop 64 as is known in the art. The coolant loop 64 has an inlet 66 and an outlet 68 to the stack 12 to cool the stack. The coolant loop 64 may have a temperature sensor 70 to determine the coolant temperature.

The stack 12 may also have a pressure sensor 72 positioned at the inlet 54 to the cathode side 16 of the stack 12. The sensor 72 may also include a temperature sensing module. A pressure sensor 74 is positioned to measure the ambient or environmental air pressure. The sensor 74 may also include a temperature sensing module.

A controller 76 receives signals from the sensors 70, 72, and other sensors that may be associated with the fuel cell system 10. The controller 76 may be a single controller or multiple controllers in communication with one another. The controller 76 is also in communication with the valve 23, valve 58, regulator 25, and motor 50. The controller 76 receives a signal from the motor that correlates to the motor and compressor speed. The controller 76 receives signals from the pressure sensors 70, 72 that provide information regarding the pressure at their respective locations. The controller 76 receives a signal from the valve 58 providing information regarding the valve 58 position. If the valve 58 is an electronic control valve, the controller 76 also controls the valve position.

The system 10 may be configured without a mass air flow sensor (as shown in FIG. 1), which may reduce system cost, weight, and modify the operation and control of the system 10. When a mass air flow sensor is omitted from the system 10, the mass flow of the air stream provided from the compressor 48 to the stack 12 needs to be predicted to control the system 10. The mass air flow provided by the compressor may vary based on the compressor operating conditions, various pressures in the system 10, the valve 58 state, etc.

During operation, an inferred mass air flow may be controlled to control stoichiometry, or fuel to air ratio, of the fuel cell system. The fuel cell operating state, environmental conditions, and the like, may also be used with the mass air flow to control the system 10. The mass air flow may be controlled using the compressor 48 and motor 50 and valve 58 on the cathode side 16 to control the flow rate of air or mass air flow to the stack 12. The fuel flow may be controlled using the valve 23 and regulator 25 on the anode side 14 to control the flow rate of fuel, or hydrogen to the stack 12. The system 10 may be operated through a range of fuel to air ratios, including fuel rich, fuel lean, and at a stoichiometric ratio of one. The mass air flow in the air stream provided by the compressor 48 may be controlled to adjust the fuel-air ratio of the system 10, where increasing the mass air flow with a constant hydrogen flow provides excess air or a leaner fuel-air ratio.

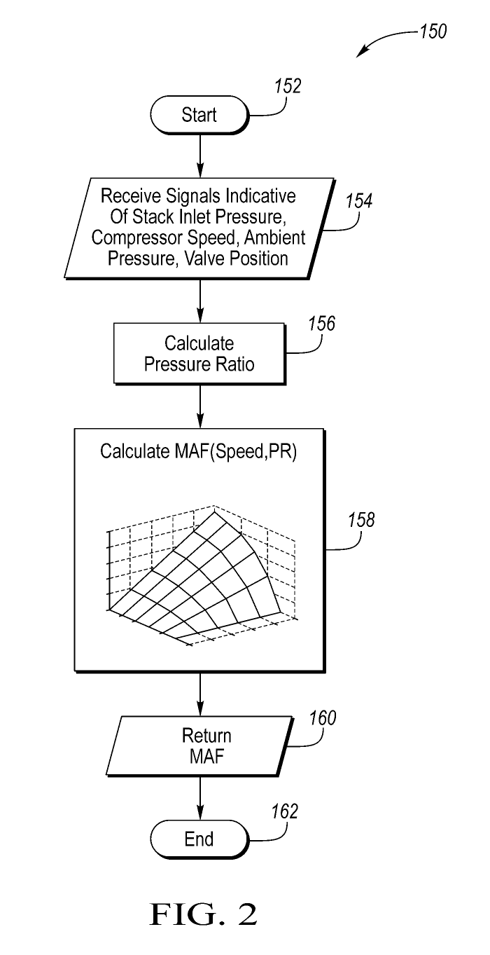

FIG. 2 is a flow chart illustrating a method 150 for using a fuel cell system according to an embodiment of the present disclosure. In other embodiments, various steps in the method 150 may be combined, rearranged, or omitted. In one embodiment, the method 150 is used by the controller 76 of the system 10 as illustrated in FIG. 1.

The method 150 begins at step 152. At step 154, a controller receives signals from various components of the fuel cell system. At step 154, a first signal indicative of an air stream pressure upstream of a compressor is received. The first signal may be the ambient air pressure, or another upstream air pressure. A second signal indicative of an air stream pressure downstream of the compressor is also received. The second signal may be the air pressure at the intake to the fuel cell stack. A third signal indicative of the compressor speed is also received. The third signal may be the compressor speed or the rotational speed of the output shaft of the electric motor driving the compressor.

With reference to FIG. 1, in one example, the first signal is provided to the controller 76 by pressure sensor 74, the second signal is provided by sensor 72, and the third signal is provided by a speed sensor associated with the compressor 48, motor 50 or a motor controller.

In some examples, a fourth signal is also received by the controller that is indicative of a position of a control valve downstream of the fuel cell stack that is adapted to control flow of the air stream. With reference to FIG. 1, the fourth signal is provided by a valve position sensor associated with valve 58 or a valve controller or actuator.

At step 156, the method 150 calculates or determines the pressure ratio across the compressor. The pressures immediately upstream and downstream of the compressor, or at the compressor inlet and outlet, may need to be determined from the pressures provided by the first and second signals, i.e. the ambient pressure and the air pressure at the stack inlet. Pressure drops caused by components and fluid connections in the system may be included in calculating the pressure ratio. For example, with reference to FIG. 1, the compressor 48 inlet pressure is determined from the ambient pressure and the pressure drop across the intake system 47. The compressor outlet pressure is determined from the intake pressure at 54 and the pressure drop across the humidification system 52. The pressure drops in the intake and humidification systems 47, 52 may each be a function of mass air flow. The fuel cell system 10 may be characterized at various flow rates and pressures to determine an associated pressure drop as a function of flow rate for each component. Alternatively, the method 150 may use the ambient and intake pressures directly a lookup or calibration table with the pressure drops provided by the various system components included in the table itself.

At step 158, the method 150 uses the pressure ratio across the compressor and the speed of the compressor to determine the mass air flow through the compressor. In one example, the method 150 uses a lookup table that correlates the pressure ratio and compressor speed with mass air flow. The table may be a three dimensional table as shown in FIG. 2, or may have fewer or greater dimensions. In another example, the method 150 may use the ambient pressure, stack intake air pressure, and the compressor speed with a lookup table that correlates the pressures, compressor speed, and pressure drops across system components with the mass air flow through the compressor. In other examples, the method 150 may use a control feedback loop to determine the mass air flow from the pressure ratio and the compressor speed.

The method 150 may also use the valve position at 158 in determining the mass air flow using either a lookup table or a control feedback loop. The valve position affects the pressure upstream of the valve, and the back pressure provided by the valve increases as the valve is moved from an open position towards a closed position. As the back pressure provided by the valve increases, the stack inlet pressure will also be affected and increases.

At step 160, the method 150 returns the mass air flow to a control system, such as controller 76 for use in controlling and operating the fuel cell system. Based on the desired electrical current and operating conditions of the fuel cell system, the controller may increase, decrease, or maintain the mass air flow. At step 162, the method 150 ends, or alternatively, returns to step 152.

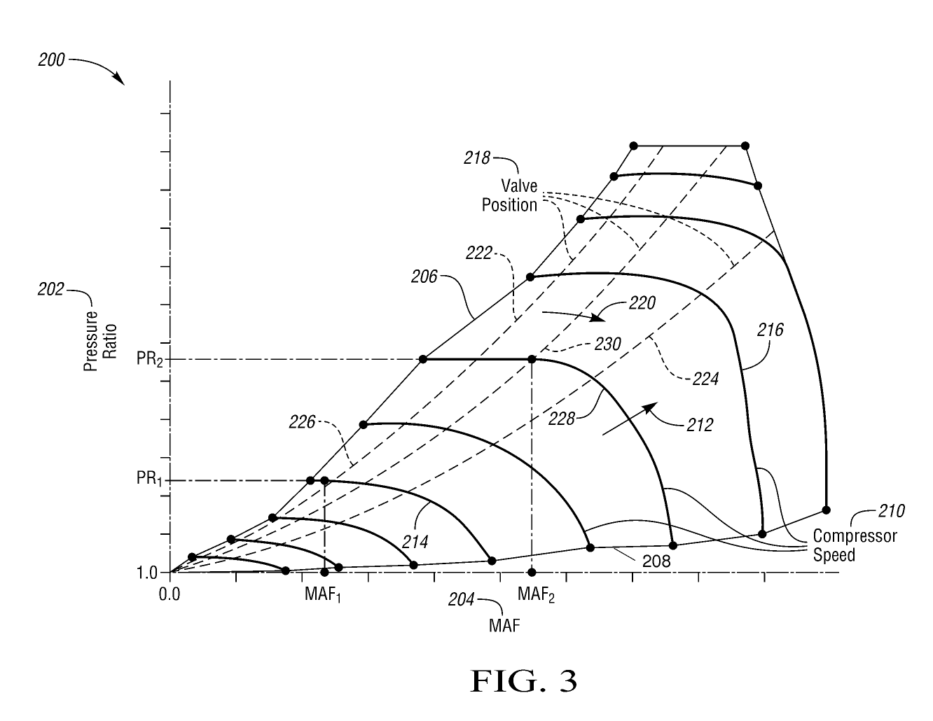

FIG. 3 illustrates a lookup table 200 for use with the method 150 according to an embodiment. The pressure ratio 202 is shown as the vertical axis. The mass air flow (MAF) 204 is shown as the horizontal axis. Lines 206, 208 illustrate the operating window of the compressor. Note that as the compressor is providing a pressure increase in the air stream, and the pressure at the compressor outlet is greater than the pressure at the compressor inlet, the pressure ratio is at least one, as shown on the axis 202.

Each line 210 illustrates a constant compressor speed of rotation. In some embodiments each line 210 is directly related to, or a function of, the output shaft speed of the electric motor driving the compressor. The compressor speed increases in the direction of arrow 212, such that the speed of compressor speed line 216 is greater than the speed of compressor speed line 214.

When the method 150 uses the lookup table 200, the constant compressor speed line is referenced in the table, for example, line 214. The pressure ratio (PR1) is then used to determine a location or position on the line 214 to provide a value for the MAF. The pressure ratio 202 may be the pressure ratio across the compressor, where any pressure drops between the pressure sensors and the compressor inlet and outlet are considered. Alternatively, the pressure ratio 202 may be the pressure ratio taken directly from the pressure sensors, and the table includes a factor or scaling to include any pressure drops as a function of flow rate in the table 200.

As can be seen from FIG. 3, PR1 intersects the line 214 along a low slope or relatively flat section of the line 214. As such, PR1 and line 214 may provide a range of possible mass air flows. The table 200 may include an additional variable to better infer the mass air flow in this scenario. Lines 218 provide lines of constant valve position for a control valve in the air stream. The control valve may be valve 58 according to one example. The valve position becomes more open in the direction of arrow 220, such that the valve position at line 224 is more open (or provides a reduced flow restriction, or less back pressure) than the valve position at line 222.

Using the valve position, the method 150 may be able to provide a more precise value for the mass air flow. For example, MAF1 is provided by the table with PR1, compressor speed line 214 and valve position line 226.

In another example using the table 200, there is a higher pressure ratio PR2 across the compressor, a higher compressor speed at line 228, and a more open valve position at line 230, providing MAF2, which is greater than MAF1.

The table 200 may be used without the valve position lines 218. In this scenario, the method 150 may use a control feedback loop to determine the MAF along a constant compressor speed line in a low slope region.

The table 200 may be a two dimensional table as shown, may also be a three dimensional table as shown in schematic in FIG. 2, or alternatively, the data may be otherwise arranged within the table to provide a similar outcome.

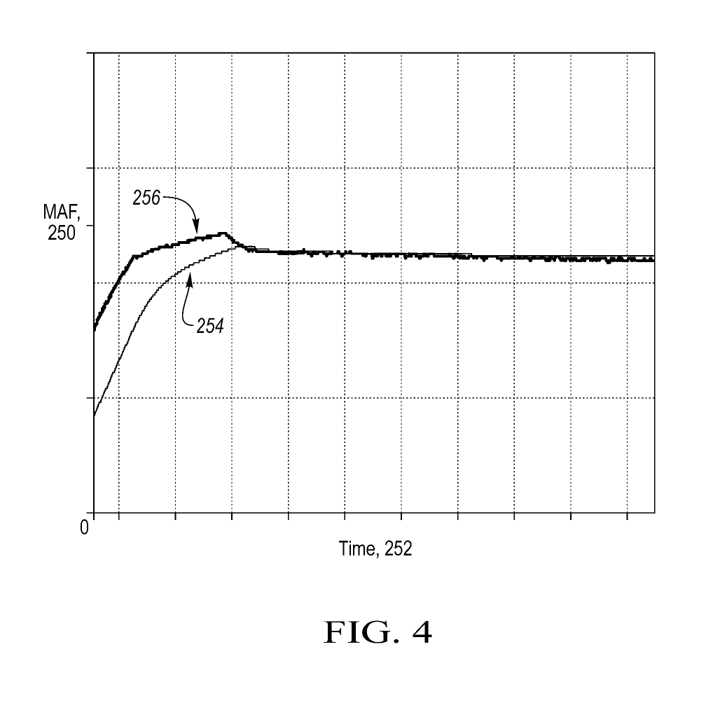

FIG. 4 illustrates preliminary test data compared to an inferred mass air flow value determined using method 150 according to an embodiment. The mass air flow 250 is plotted versus time 252 and includes fuel cell system start up (transient operation) and normal steady operation (steady state operation). Line 254 represents the mass air flow measured for the system using a mass air flow sensor. Line 256 represents the inferred mass air flow through the system as determined using method 150 and table 200. For the example shown, the method 150 uses table 200 without the valve position information, i.e. only the compressor speed and pressure ratio are used in determined in the mass air flow shown at line 256. As can be seen by FIG. 4, the inferred mass air flow matches with the measured mass air flow once the fuel cell system reaches a steady state operation.

During transient operation, the conditions in the fuel cell system, including the valve position, compressor speed, and/or pressure ratio, may be rapidly changing. The inferred mass air flow line 256 infers a MAF value that is above the actual value during the initial start up or transient operation; however, inclusion of the valve position and/or a data filter may provide a better inferred MAF 256 during transient operation.

Various embodiments of the present disclosure have associated, non-limiting advantages. For example, operation of a fuel cell system uses a control algorithm. The control algorithm may use feedback sensors. The fuel cell stack uses air and hydrogen at a desired pressure, flow, and humidity to produce electrical current. The control algorithm controls a compressor, such as an electronic supercharger, to deliver the desired air pressure and flow. A conventional system uses a mass air flow sensor and one or more air pressure sensors. Each sensor used in the fuel cell system increases the cost and complexity of the fuel cell system. The present disclosure provides for a fuel cell system without a mass air flow sensor where the controller infers the mass air flow based on the speed of the compressor and the pressure drop across the compressor. The controller may also use a control valve position, where the valve position sets a back pressure in the system, in inferring the mass air flow. Other pressure drops in the system may be considered by the controller including the air inlet or induction system, the air humidification system, etc. The controller uses a method that controls the operation of the fuel cell system to a desired mass air flow and air pressure based on the inferred mass air flow, which is a function of pressure ratio across the compressor, the compressor speed, and/or the valve position. The controller may use a feedback loop or a lookup table to determine the inferred mass air flow.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A fuel cell system comprising:
a fuel cell stack;
a compressor providing an air stream to the fuel cell stack;
a first pressure sensor adapted to measure a first air pressure at a first location in the system;
a second pressure sensor adapted to measure a second air pressure of the air stream at a second location in the system; and
a controller configured to (i) infer a mass air flow of the air stream using a speed of the compressor and a pressure ratio across the compressor, the pressure ratio being determined from the first air pressure and the second air pressure, and (ii) control an operation of the fuel cell stack using the mass air flow through the compressor.

2. The system of claim 1 further comprising a valve positioned downstream of the fuel cell stack and configured to control a flow of the air stream through the stack;
wherein the controller is configured to receive a signal indicative of a position of the valve; and
wherein the controller is further configured to infer the mass air flow using the speed of the compressor, the pressure ratio across the compressor, and the position of the valve.

3. The system of claim 2 wherein the controller includes a lookup table in memory thereof and is further configured to infer the mass air flow based on the speed of the compressor, the pressure ratio, and the position of the valve as inputs into the lookup table.

4. The system of claim 1 wherein the controller is further configured to infer the mass air flow using the speed of the compressor and the pressure ratio across the compressor using a feedback loop.

5. The system of claim 1 wherein the controller is further configured to receive a first signal indicative of the first air pressure from the first pressure sensor and receive a second signal indicative of the second air pressure from the second pressure sensor.

6. The system of claim 1 wherein the controller is further configured to receive a signal indicative of the speed of the compressor from the compressor.

7. The system of claim 1 wherein the controller includes a lookup table in memory thereof and is further configured to infer the mass air flow based on the speed of the compressor and the pressure ratio as inputs into the lookup table.

8. The system of claim 1 wherein the first air pressure is an ambient air pressure.

9. The system of claim 8 wherein the second location corresponds to an air inlet to the stack.

10. The system of claim 1 further comprising an air humidification system positioned between the compressor and the stack and providing a pressure drop thereacross;
wherein the pressure ratio is determined from the first air pressure and the second air pressure and from the pressure drop across the air humidification system.

11. The system of claim 10 wherein the pressure drop across the air humidification system is a function of air flow therethrough.

12. The system of claim 1 further comprising an air inlet system that provides ambient air to the compressor and provides an associated pressure drop thereacross;
wherein the pressure ratio is determined from the first air pressure and the second air pressure and from the pressure drop across the air inlet system.

13. The system of claim 1 wherein the compressor is an electronic supercharger.

14. A fuel cell system comprising:
a fuel cell stack for generating power;
a compressor providing an air stream to the stack; and
a controller configured to, in response to determining a mass air flow through the compressor from a lookup table using a speed of the compressor and a pressure ratio across the compressor, operate the fuel cell system based on the mass air flow.

15. The system of claim 14 wherein the controller is further configured to receive a first signal indicative of an inlet pressure to a cathode from a first pressure sensor;
wherein the controller is further configured to receive a second signal indicative of an ambient pressure from a second pressure sensor; and
wherein the first signal and the second signal are used to determine the pressure ratio.

16. The system of claim 14 wherein the controller is further configured to receive a signal indicative of a position of a valve downstream of the cathode, and
wherein the controller is further configured to determine the mass air flow through the compressor from the lookup table using the speed of the compressor, the pressure ratio across the compressor, and the position of the valve.

17. A method for controlling a fuel cell system comprising:
receiving first and second signals at a controller indicative of air pressure upstream and downstream of a compressor respectively;
receiving a third signal at the controller indicative of a speed of the compressor; and
operating the fuel cell system at a desired mass air flow based on an inferred mass air flow determined using the first, second, and third signals.

18. The method of claim 17 further comprising receiving a fourth signal at the controller indicative of a position of a valve controlling air flow downstream of the stack;
wherein the fuel cell system is operated at the desired mass air flow based on the inferred mass air flow determined using the first, second, third, and fourth signals.

19. The method of claim 17 wherein the first signal is indicative of ambient pressure upstream of the air compressor and the second signal is indicative of inlet pressure at a stack inlet.

20. The method of claim 17 further comprising operating the fuel cell system at the desired mass air flow based on the inferred mass air flow determined using the first, second, and third signals and a system air pressure drop between the compressor and a stack inlet, wherein the system air pressure drop is a function of air flow.
